(19) United States
(12) Patent Application Publication
(10) Pub. No.: US 2012/0085487 A1
(43) Pub. Date: Apr. 12, 2012

(54) Multi-Layered Product Having Dimpled Interior and Method of Making Same

(75) Inventor: Judson A. Bradford, Holland, MI (US)

(73) Assignee: BRADFORD COMPANY, Holland, MI (US)

(21) Appl. No.: 12/901,883

(22) Filed: Oct. 11, 2010

(51) Int. Cl. B29C 47/06

(52) U.S. Cl. 156/244.12

(57) ABSTRACT

A process of making a multi-layered product made from multiple extruded sheets or webs of material laminated or joined together. In several embodiments, at least one of the webs is extruded such that the extrudate has different properties. When introduced into a dimpler, the extrudate is treated such that a plurality of dimples are created in the web. A pair of outer skins are laminated or applied to the dimpled interior layer. The outer skins may have identical properties or different properties within each outer skin.

### FIELD OF THE INVENTION

This invention relates generally to a multi-layered product for structural, packaging, and other applications and the process of making the product.

### BACKGROUND OF THE INVENTION

In the packaging industry, dimpled products have been used as a core component for sandwich panels and boards that are resistant to buckling and bending. The dimpled product is commonly sandwiched between generally planar plastic layers to create a multilayered product. One such product is sold in the United States under the trademark Con-Pearl®.

A sandwich structure may be prepared having two cover layers or skins which are welded, adhesively bonded or otherwise secured to the interior dimpled layer or sheet to create a multi-layered or multi-laminate material. Interest expressed in other industrial sectors concerning the use of lightweight sandwich structures is continually growing, due at least in part to the realization of its high strength properties while maintaining a relatively low structural weight per volume of product.

A multi-layered or multi-laminate material having a dimpled product as the core thereof may be used in the packaging industry. However, in automobile part packaging and comparable markets, such a product must compete with corrugated paperboard or corrugated plastic or like materials which may be produced quickly and relatively inexpensively.

Commonly, such multi-layered or multi-laminate sheets have uniform properties across their length and/width. There is no customization.

Accordingly, there is a need for a multi-laminate product which has different properties while maintaining a favorable strength-to-weight ratio.

There is further a need for a process for manufacturing a multi-layered product having a dimpled interior layer which has different properties in different portions of the product.

### SUMMARY OF THE INVENTION

One aspect of the present invention comprises a process for producing a sandwich-like or multi-layered product having an interior dimpled layer. The product may have any number of layers; the product is not intended to be limited to three layers. The processes of the present invention may be used to make products for use in any desired environment or industry, including but not limited to, packaging materials.

According to one aspect of this invention, a process of making a multi-layered product comprises extruding a web of material such that the extruded web has portions of differing thicknesses. Another way to say this is that the extruded web has a non-planar profile, i.e., a non-rectangular cross-section. Shapes of other webs of material not shown are intended to be included in such a definition. The extrudate displays a non-planar cross-sectional configuration upon exiting the extruder head. This cross-section may assume any of a variety of shapes.

Representative product may be produced using a variety of starting materials capable of being processed through an extruder, including various plastic compositions, in an efficient manner to produce a product having necessary strength-to-weight properties.

According to one aspect of this invention, a process of making a multi-layered product comprises extruding a web of material such that the extruded web has portions of differing thicknesses. The process further comprises treating the extruded web of material to create a dimpled interior web having a plurality of dimples. The process further comprises applying outer skins to the dimpled interior web to create a multi-layered web. Additionally, the process may comprise cutting the multi-layered web to a desired size.

As defined herein, the term “web” encompasses material processed in extrusion equipment intended to accept the specific material introduced into that equipment, and issuing or exiting from an extruder head.

In another aspect of the invention, a process of making a multi-layered product comprises co-extruding a web of material such that the extruded web has portions with different properties. The process further comprises treating the extruded web of material to create a dimpled interior web having a plurality of dimples. The process further comprises applying outer skins to the dimpled interior web to create a multi-layered web. Additionally, the process may further comprise cutting the multi-layered web to a desired size.

In another aspect of the present invention, at least one of the outer skins may be co-extruded with at least two different materials having different properties. The outer skins are then laminated or joined to the dimpled interior web. The interior web may have uniform properties throughout. Alternatively, the dimpled interior layer of the product may have different properties in different areas or portions of the dimpled web.

In another aspect of the present invention, at least one of the outer skins may be extruded such that the web or skin has different thicknesses. A multi-layered product produced with an outer skin, or outer skins which are not of a uniform thickness, may have areas or regions of increased strength relative to other areas or regions of the resultant product.

### BRIEF DESCRIPTION OF THE DRAWINGS

The objectives and features of the present invention will become more readily apparent when the following detailed description of the drawings is taken in conjunction with the accompanying drawings in which:

FIG. 1 is a perspective view of a web of material having a generally non-planar cross-section being extruded from an extruder;

FIG. 2 is a perspective view of a web of material having a generally non-planar cross-section being extruded from an extruder head of FIG. 1;

FIG. 3A is a cross-sectional view of a portion of the extruded web of FIG. 1 taken along the line 3A-3A;

FIG. 3B is a cross-sectional view of an alternative extrusion;

FIG. 3C is a cross-sectional view of an alternative extrusion;

FIG. 4 is a perspective view of a portion of the extruded web of FIG. 2 being treated by a dimpler to create a dimpled web;

FIG. 4A is a cross-sectional view taken along the line 4A-4A of FIG. 4;

FIG. 4B is a cross-sectional view of an alternative embodiment of a dimpled web;

FIG. 5 is a perspective view of a portion of outer skins being laminated or joined to the dimpled web of FIG. 4;

FIG. 5A is a cross-sectional view of a portion of the multi-layered web of FIG. 5 taken along the line 5A-5A;

FIG. 5B is a cross-sectional view of an alternative embodiment of multi-layered web;

FIG. 6 is a side elevation view of a plurality of multi-layered products made in accordance with the present invention being stacked on a pallet;

FIG. 7 is a perspective view of a portion of the extruded web of FIG. 2 being treated by another dimpler to create another dimpled web according to another aspect of the present invention;

FIG. 7A is a cross-sectional view taken along the line 7A-7A of FIG. 7;

FIG. 8 is a disassembled perspective view of portions of alternative outer skins being secured to a portion of a dimpled interior web according to another aspect of this invention;

FIG. 9 is a disassembled perspective view of portions of alternative outer skins being secured to a portion of a dimpled interior web according to another aspect of this invention;

FIG. 10 is a perspective view of a portion of a co-extruded web being treated by a dimpler to create a dimpled web; and

FIG. 11 is a disassembled perspective view of portions of outer skins being secured to a portion of a dimpled interior web of FIG. 10.

### DETAILED DESCRIPTION OF THE DRAWINGS

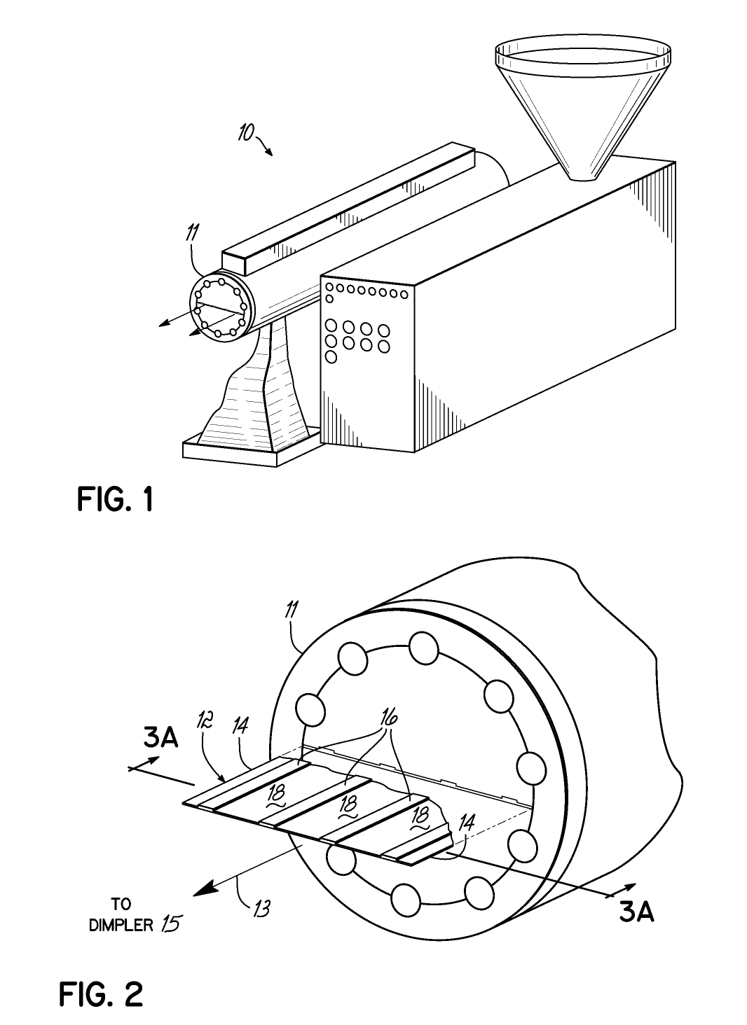

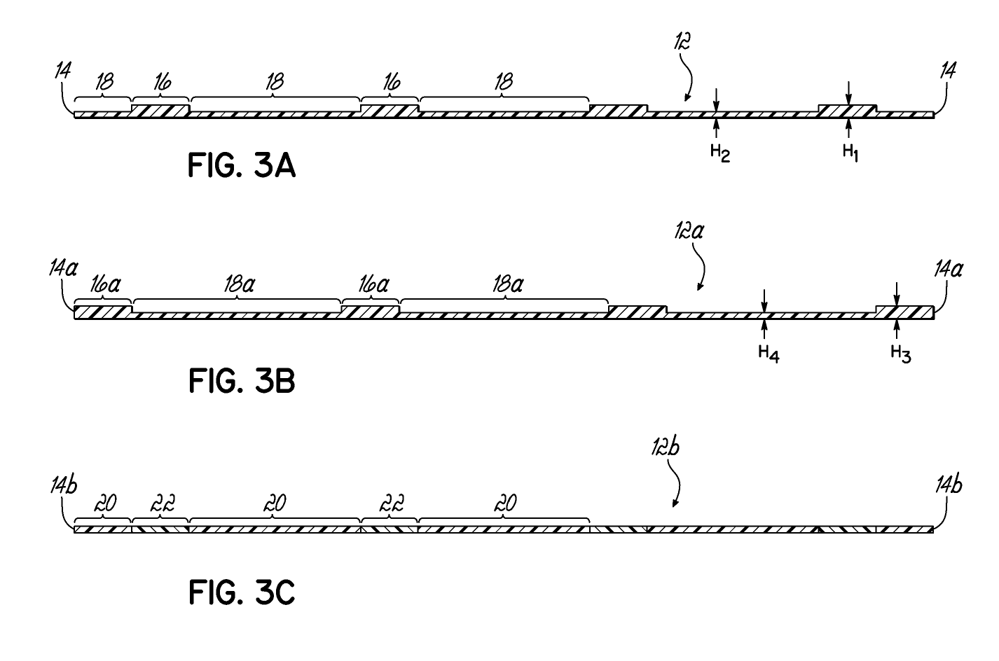

Referring to the drawings, and particularly to FIG. 1, an extruder 10 extruding a web of material 12 is illustrated. The extruded web of material 12 is shown in more detail in FIGS. 2 and 3A. Although one configuration of extruder 10 and extruder head 11 is illustrated, any type or configuration of extruder known in the art may be used. The extruder and extruder head configurations will vary as a function of the material being extruded and the cross-section of the extrudate. The material can include any of a variety of plastic compositions and any other material capable of being extruded, and can encompass additional compositions which can be further processed to produce a multi-layered product for packaging or other applications.

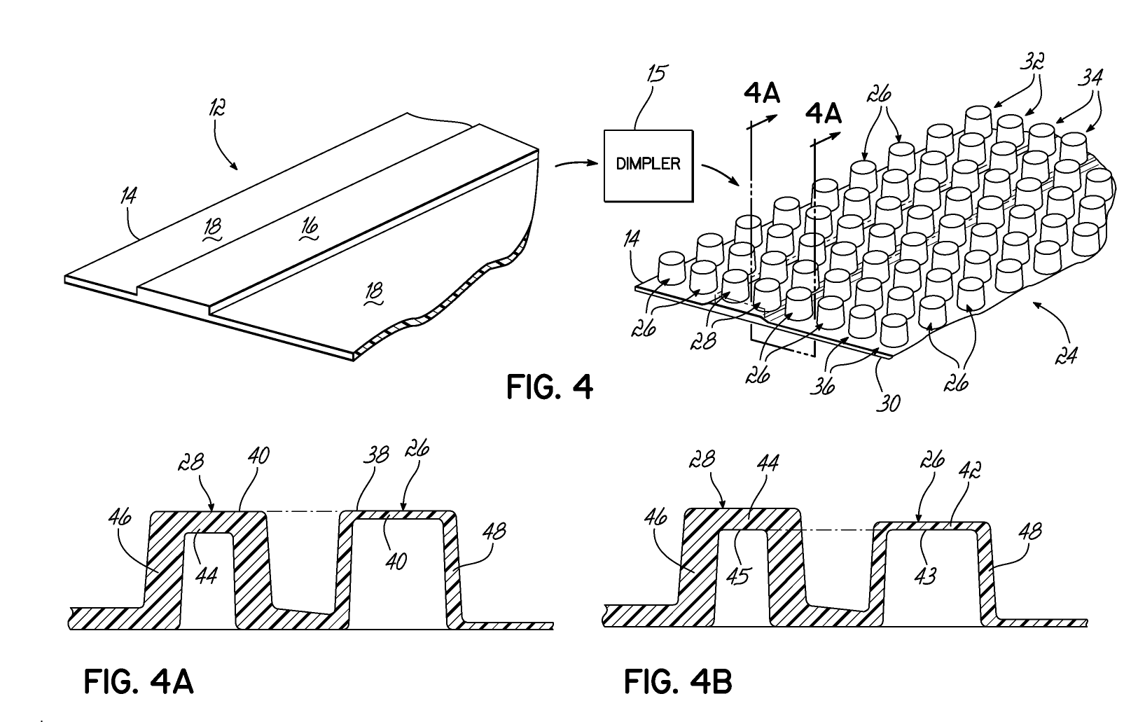

In FIG. 2, the extruded web 12 travels in a direction indicated by arrow 13 to a dimpler 15 (shown schematically in FIG. 4). The extruded web 12 has a pair of opposed side edges 14, the linear distance between which defines the width or transverse dimension of the extruded web 12. The extruded web 12 may be any desired material of any desired width.

As best illustrated in FIG. 3A, extruded web 12 is generally non-planar, i.e., has a generally non-rectangular cross-section or cross-sectional configuration. In cross-section, the extruded web 12 has a plurality of thick portions 16 and a plurality of thin portions 18. The thick portions 16 are spaced apart from each other and have a greater height or thickness H₁ than the height or thickness H₂ of the other thin portions 18. The outermost thick portions 16 are spaced inwardly from the outer edges 14 of the extruded web in the embodiment shown in FIG. 3A.

Although one shape or configuration of extruded web 12 is illustrated in FIG. 3A, the extruded web 12 may assume numerous other non-rectangular configurations in cross-section. For example, FIG. 3B shows an alternate cross-sectional shape of extrudate 12 which is non-planar in cross-section. FIG. 3B illustrates an alternative embodiment of extruded web 12a extruded via an alternative extruder head (not shown). Like the extrudate 12 shown in FIG. 3A, the extrudate 12a shown in FIG. 3B has a plurality of spaced thick portions 16a and a plurality of spaced thin portions 18a located and spanning between the thick portions 16a. The thick portions 16a have a greater height or thickness H₃ than the height or thickness H₄ of the other thin portions 18a. The outermost thick portions 16a extend inwardly from the outer edges 14a of the extruded web 12a in the embodiment shown in FIG. 3B. Although FIGS. 3A and 3B illustrate two versions of extruded web, they are not intended to limit the number of possible configurations of extrudate. Any extrudate having portions of differing thickness is intended to be within the scope of the present invention.

FIG. 3C illustrates a cross-sectional view of an alternative extrudate or extruded web 12b which is generally planar, but made of two different materials. This extruded web 12b has opposing outer edges 14b and is co-extruded using two different materials, as is known in the art. As shown in FIG. 3C, the extruded web 12b has outermost portions and spaced internal portions made of a first material 20. In between the portions 20 made of the first material are portions 22 made of a second material having different properties than the first material. For example, the first material may be a different type of plastic, a different density and/or color than the second material. These listed properties are not intended to be exhaustive and any other properties may be different between the first and second materials.

FIG. 4 illustrates another step in the process of making a multi-layered product. This step comprises passing the extruded web 12 through a dimpler 15 which results in a dimpled interior web 24 having a plurality of dimples 26, 28 extending upwardly from a bottom portion 30 of the dimpled interior web 24.

FIG. 4A illustrates a view taken along line 4A-4A of FIG. 4 and shows differences in the dimples 26, 28 formed from the alternating thick and thin portions 16, 18 of extruded web 12 after the extruded web 12 has passed through the dimpler 15. As shown in FIG. 4, the outermost two columns 32 of dimples 26 extending in the direction of travel 13 of the web 12 have been pushed upwardly from one of the thin portions 18 of the web 12. The next two columns 34 of dimples 28 extending in the direction of travel 13 of the web 12 have been pushed upwardly from one of the thick portions 16 of the web 12. Moving from left to right in FIG. 4, the next four columns 36 of dimples 26 extending in the direction of travel 13 of the web 12 have been pushed upwardly from one of the thin portions 18 of the web 12.

FIG. 4A shows one of the dimples 28 made from one of the thick portions 16 of the extruded web 12 and one of the dimples 26 made from one of the thin portions 18 of the extruded web 12. As seen in FIG. 4A, due to the thicker material in the thick portion 16 of the extruded web 12 as compared to the thin portion 18 of the extruded web 12, the dimple 28 has increased top and sidewall thicknesses when compared to the top and sidewall thicknesses of the dimple 26.

Depending upon the type of dimpler used in the process, the dimples 26, 28 may have top walls 42, 44, respectively, having co-planar upper surfaces 38, 40, as shown in FIG. 4A. Alternatively, if a different type of dimpler is used, the dimples 26, 28 may have co-planar inner surfaces 43, 45 of their top walls 42, 44, respectively, as shown in FIG. 4B.

In the embodiments shown in FIGS. 4A and 4B, the top walls 44 of the dimples 28 are thicker than the top walls 42 of the dimples 26 due to the extruded web 12 being thicker or having more material in areas 16 when compared to areas 18 before the extruded web 12 is passed through the dimpler. Similarly, the sidewalls 46 of the dimples 28 are thicker than the sidewalls 48 of the dimples 26 due to the extruded web being thicker or having more material in areas 16 when compared to areas 18 before the extruded web 12 is passed through the dimpler.

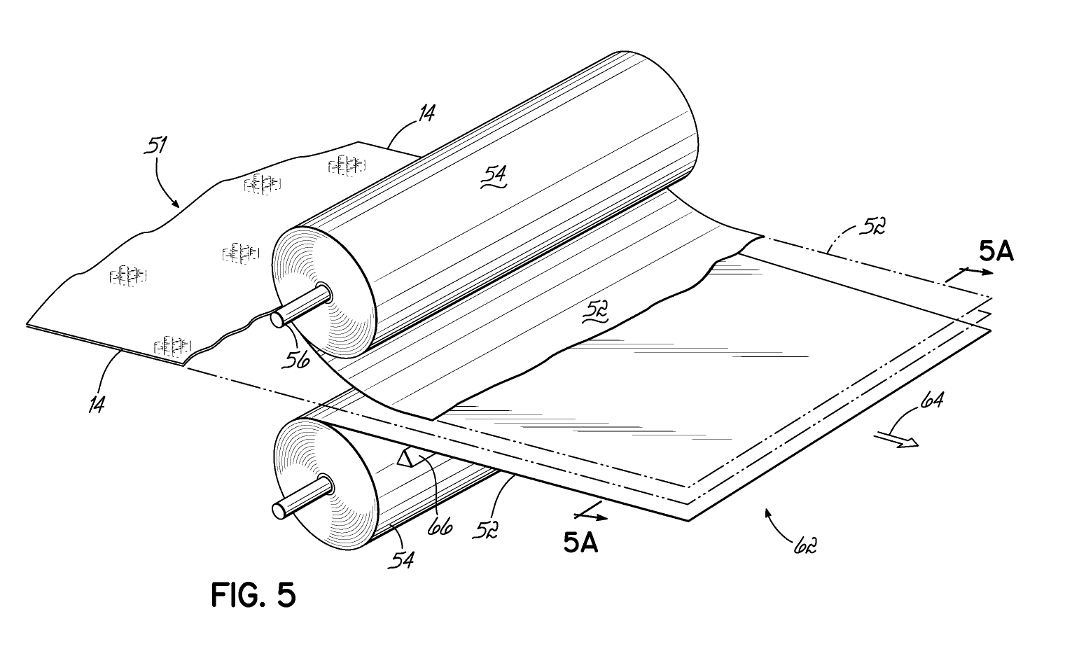

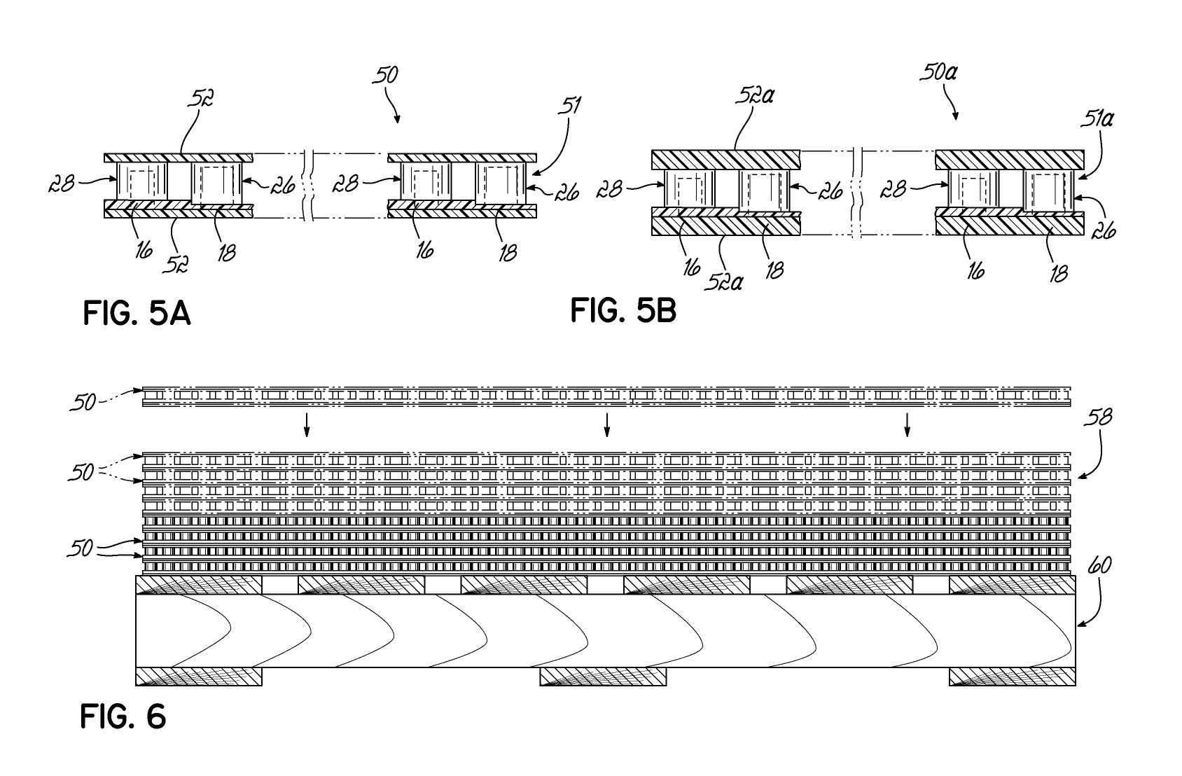

FIG. 5 illustrates another step in the process of making a multi-layered product, like the multi-layered product 50 shown in FIG. 5A. FIG. 5 illustrates a pair of outer skins 52 being secured to or laminated to a dimpled interior web 51, like dimpled web 24 illustrated in FIG. 4 to create a continuous multi-layered web 62 moving in the direction of arrow 64. Each outer skin 52 is extruded in a known manner, then rolled into a roll 54 about a core 56. As shown in FIG. 5, one of the rolls 54 is above the dimpled interior web 51 and the other is below the dimpled interior web 51. However, the rolls 54 may be at any desired locations.

A cutter 66, shown in FIG. 5, is adapted to cut the multi-layered web 62 to a desired size to end up with a multi-layered product like multi-layered product 50 shown in FIG. 5A or multi-layered product 50a shown in FIG. 5B.

FIG. 5A illustrates a multi-layered product 50 comprising a pair of outer skins or protective layers 52 secured to opposing sides of an interior dimpled layer 51 in accordance with the present invention. FIG. 5B illustrates an alternative multi-layered product 50a comprising a pair of outer skins or protective layers 52a, thicker than outer skins 52 shown in FIG. 5A, secured to opposing sides of an interior dimpled layer 51a. Although FIGS. 5A and 5B illustrate outer skins of different thicknesses being secured to a dimpled interior layer, any of the outer skins described or shown in this document may be used with any of the dimpled interior layers shown or described in this document.

FIG. 6 illustrates a plurality of multi-layered products 50 arranged in a stack 58 on top of a pallet 60 and another product 50 being placed on top of the stack 58. Using this stacking procedure, any number of multi-layered products made in accordance with the present invention may be shipped to a desired location.

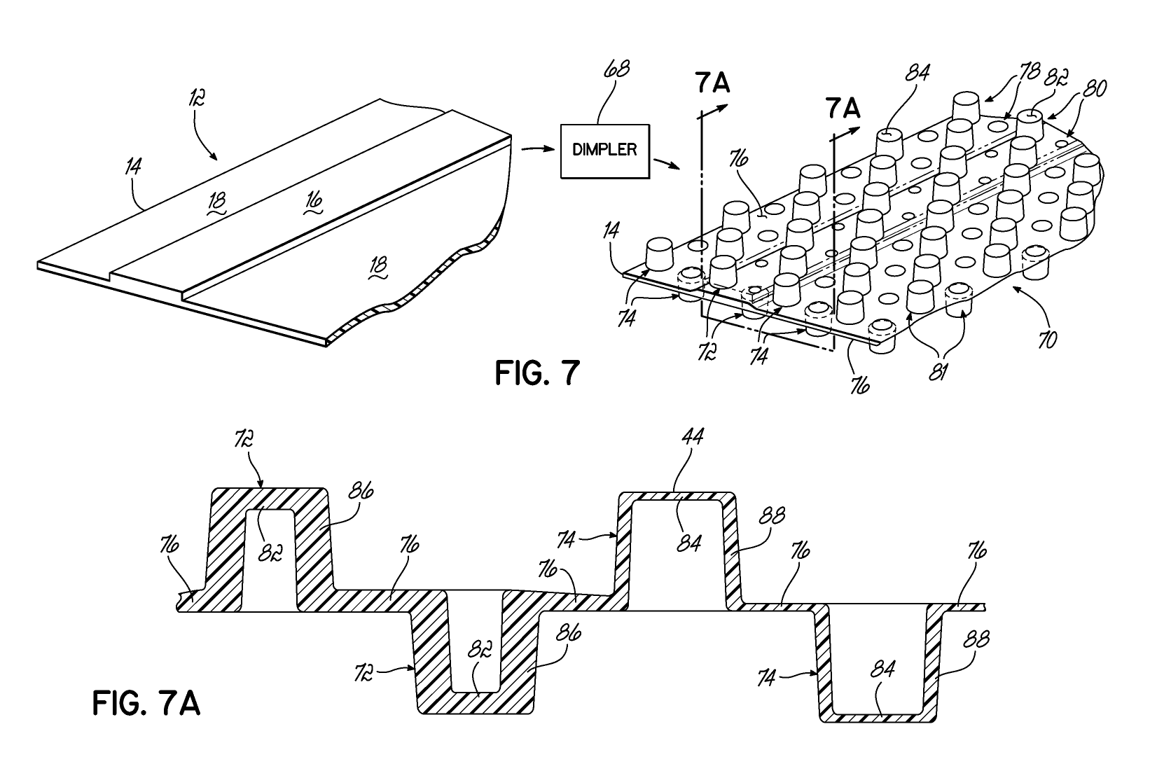

FIG. 7 illustrates an alternative dimpler 68 which may be used in the process of making a multi-layered product. This step comprises passing the extruded web 12 shown in FIG. 4 through a dimpler 68 which results in a dimpled interior web 70 having a plurality of dimples 72, 74 each extending upwardly and downwardly from a planar portion 76 of the dimpled interior web 70.

FIG. 7A shows differences in the dimples 72, 74 made from the alternating thick portions 16 and thin portions 18 of extruded web 12 after the web 12 has passed through the dimpler 68. As shown in FIG. 7, the outermost two columns 78 of dimples 72 extending in the direction of travel 13 of the web 12 have been pushed outwardly (both upwardly and downwardly) from one of the thin portions 18 of the web 12. The next two columns 80 of dimples 72 extending in the direction of travel 13 of the web 12 have been pushed outwardly (both upwardly and downwardly) from one of the thick portions 16 of the web 12. Moving from left to right in FIG. 7, the next four columns 81 of dimples 74 extending in the direction of travel 13 of the web 12 have been pushed outwardly (both upwardly and downwardly) from one of the thin portions 18 of the web 12. FIG. 7A shows two of the dimples 72, one extending up and one extending down, made from one of the thick portions 16 of the extruded web 12 and two of the dimples 74, one extending up and one extending down, made from one of the thin portions 18 of the extruded web 12. As seen in FIG. 7A, due to the thicker material in the thick portion 16 of the extruded web 12 when compared to the thin portion 18 of the extruded web 12, each of the dimples 72 has an increased wall thickness when compared to the wall thickness of the dimples 74, both on the top and around the sides of the dimples.

In the embodiment shown in FIGS. 7 and 7A, the horizontal or outermost walls 82 of the dimples 72 are thicker than the horizontal or outermost walls 84 of the dimples 74 due to the extruded web 12 being thicker or having more material in areas 16 when compared to areas 18 before the extruded web 12 is passed through the dimpler 68. Similarly, the sidewalls 86 of the dimples 72 are thicker than the sidewalls 88 of the dimples 74 due to the extruded web being thicker or having more material in areas 16 when compared to areas 18 before the extruded web 12 is passed through the dimpler 68.

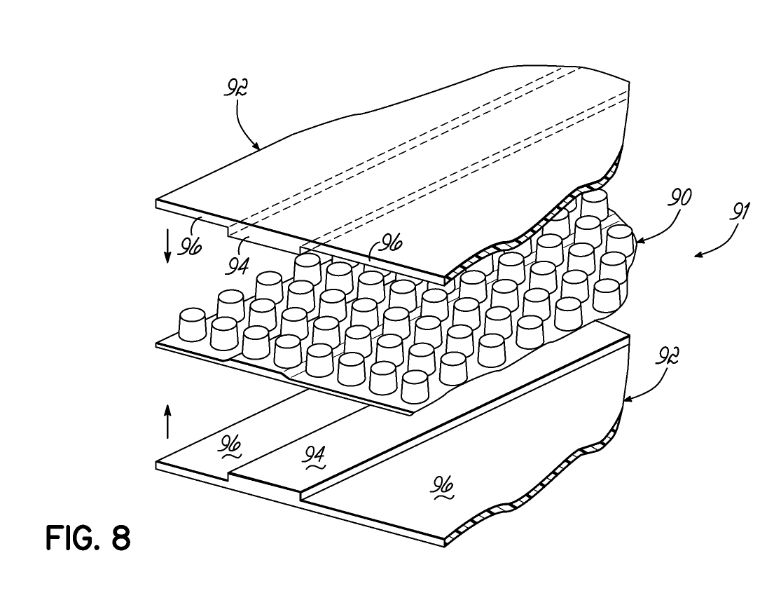

FIG. 8 illustrates a portion of an alternative embodiment of multi-layered web 91 which may be cut to any desired size to make a multi-layered product. FIG. 8 shows an interior dimpled layer or web 90 like interior dimpled layer 24 shown in FIG. 4. However, any dimpled layer including the one shown in FIGS. 7 and 7A, may be used in this embodiment. What makes this embodiment different is that the outer skins or layers 92 are of uneven thickness. Like the extruded web 12 used to make a dimpled layer, the extruded webs or skins 92 have thick portions or strips 94 extending in the direction of travel of the web 92 which are thicker, i.e., have more material, than thin portions or strips 96. Although each of the webs 92 is illustrated having a particular configuration, it is within the scope of the present invention that any web having different thicknesses may be used as the outer skins of a multi-layered web and subsequent product.

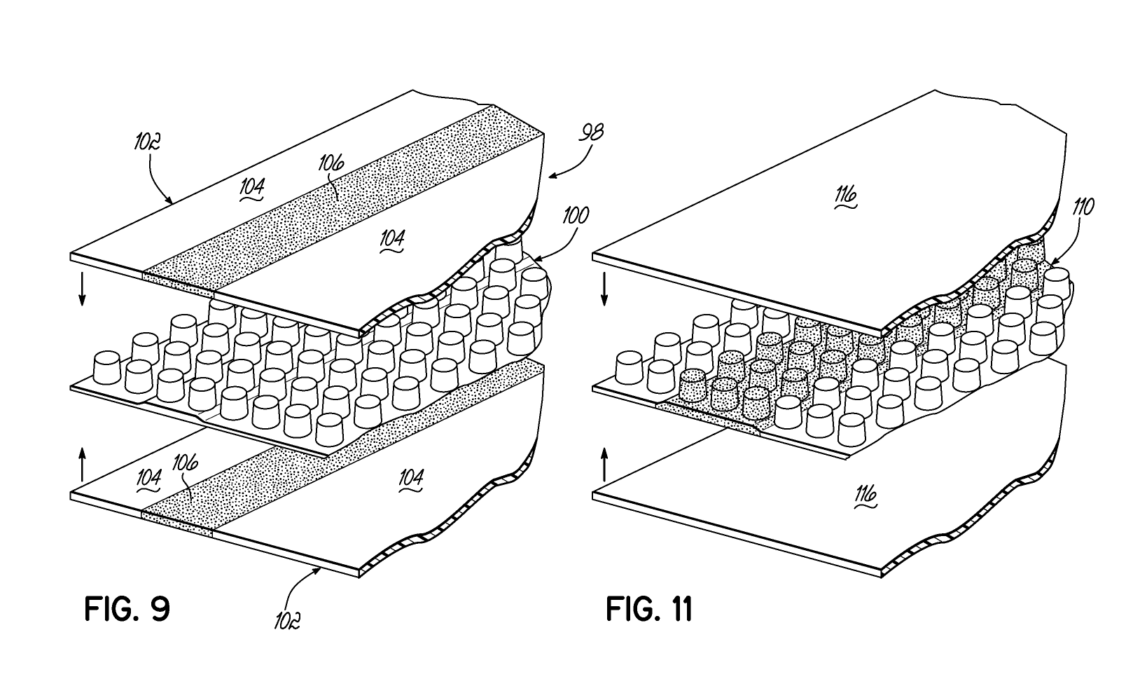

FIG. 9 illustrates a portion of an alternative embodiment of multi-layered web 98 which may be cut to any desired size to make a multi-layered product. FIG. 9 shows an interior dimpled layer or web 100 like interior dimpled layer 24 shown in FIG. 4. However, any dimpled layer, including the one shown in FIGS. 7 and 7A, may be used in this embodiment. What makes this embodiment different is that the outer skins or layers 102 comprise multiple materials having different properties. Like the extruded web 12b shown in FIG. 3C used to make a dimpled layer, the extruded webs of material 102 have a first material 104 and a second material 106, each material extending in strips in the direction of travel of the web 102 and having at least one property which differs from the other material. Commonly, such webs of material 102 are co-extruded. Although each of the webs 102 is illustrated having a particular configuration, it is within the scope of the present invention that any web co-extruded with different materials or materials have different properties may be used as the outer skins of a multi-layered web and subsequent product.

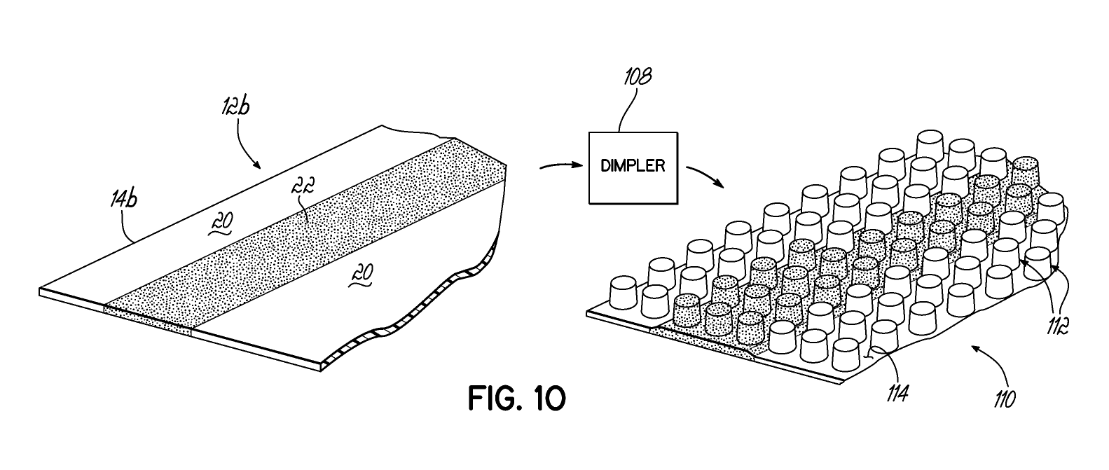

FIG. 10, like FIG. 4, illustrates the step in the process of making a multi-layered product comprising passing an extruded web through a dimpler which results in a dimpled interior web having a plurality of dimples extending outwardly from a planar portion of the dimpled interior web. However, in FIG. 10, the co-extruded web 12b, shown in cross-section in FIG. 3C, is shown passing through a dimpler 108 which results in a dimpled interior web 110 having a plurality of dimples 112 extending upwardly from a planar portion 114 of the dimpled interior web 110. Although not shown, it is within the scope of the invention that a co-extruded web similar to co-extruded web 12b shown in FIG. 3C may be passed through a different dimpler, such as dimpler 68 shown in FIG. 7 to create a dimpled interior web in which the dimples extend in opposite directions.

FIG. 11 illustrates a portion of an alternative embodiment of multi-layered web 114 which may be cut to any desired size to make a multi-layered product. FIG. 11 shows the interior dimpled layer or web 110 of FIG. 10 being sandwiched between outer skins 116. Although plain uniform outer skins are illustrated in FIG. 11, any outer skins, including the ones shown in FIGS. 8 and/or 9, may be used in this embodiment or any embodiment. What makes this embodiment different is that the interior dimpled layer or web 110 comprises multiple materials having different properties. Like the extruded webs 102 shown in FIG. 10 used to make the outer protective layers, the interior dimpled layer or web 110 is made from a first material 20 and a second material 22, each material extending in strips in the direction of travel of the web 110 and having at least one property which differs from the other material. Although web 110 is illustrated having a particular configuration, it is within the scope of the present invention that any dimpled web with different materials or materials having different properties may be used as the interior dimpled layer of a multi-layered web and subsequent product.

While I have described several preferred embodiments of the present invention, persons skilled in the art will appreciate changes and modifications which may be made without departing from the spirit of the invention. For example, although one configuration of dimple is illustrated and described, the dimples of the present invention may be other configurations. Therefore, I intend to be limited only by the scope of the following claims and equivalents thereof.

I claim:

1. A process of making a multi-layered product comprising:
extruding a web of material such that the extruded web has portions of differing thicknesses;
treating the extruded web of material to create a dimpled interior web having a plurality of dimples; and
applying outer skins to the dimpled interior web to create a multi-layered web.

2. The process of claim 1 further comprising cutting the multi-layered web.

3. The process of claim 1 wherein the portions of the extruded web which are thicker than other portions of the web extend in the direction of travel of the web.

4. The process of claim 2 wherein the thicker portions of the web are spaced from one another.

5. The process of claim 1 wherein the thicker portions of the web extend proximate outer edges of the web.

6. The process of claim 1 wherein the dimples of the extruded web have different wall thicknesses than other dimples of the extruded web.

7. The process of claim 1 wherein some of the dimples of the extruded web have different wall thicknesses than the wall thicknesses of other dimples of the extruded web.

8. The process of claim 1 wherein the outer surfaces of the upper walls of the dimples are generally co-planar.

9. The process of claim 1 wherein the inner surfaces of the upper walls of the dimples are generally co-planar.

10. The process of claim 1 wherein the outer skins are different thicknesses.

11. The process of claim 1 wherein at least one of the outer skins has different properties in different areas.

12. The process of claim 1 wherein both of the outer skins have different properties in different areas.

13. The process of claim 1 wherein at least one of the outer skins is made of at least two different materials.

14. The process of claim 1 wherein each of the outer skins is made of at least two different materials.

15. A process of making a multi-layered product comprising:
extruding a web of material such that the extruded web has portions with different properties;
treating the extruded web of material to create a dimpled interior web having a plurality of dimples;
applying outer skins to the dimpled interior web to create a multi-layered web; and
cutting the multi-layered web.

16. The process of claim 15 wherein the extruding step comprises co-extruding different materials.

17. The process of claim 15 wherein the outer skins are the same thicknesses.

18. The process of claim 15 wherein the outer skins are different thicknesses.

19. The process of claim 15 wherein at least one of the outer skins has different properties in different areas.

20. The process of claim 15 wherein both of the outer skins have different properties in different areas.

21. The process of claim 15 wherein at least one of the outer skins is made of at least two different materials.

22. The process of claim 15 wherein each of the outer skins is made of at least two different materials.
